(19) United States
(12) Patent Application Publication
(10) Pub. No.: US 2025/0004351 A1
(43) Pub. Date: Jan. 2, 2025

(54) Broadband Source of Quantum-Entangled Photons

(71) Applicant: Mina ESMAEELPOUR, Rolla, MO (US)

(72) Inventor: Mina ESMAEELPOUR, Rolla, MO (US)

(73) Assignee: The Curators of the University of Missouri, Columbia, MO (US)

(21) Appl. No.: 18/424,358

(22) Filed: Jan. 26, 2024

Related U.S. Application Data
(60) Provisional application No. 63/481,677, filed on Jan. 26, 2023.

(51) Int. Cl. G02F 1/35

(52) U.S. Cl. CPC G02F 1/3526; G02F 1/3503; G02F 1/3536; G02F 2201/02; G02F 2201/05

(57) ABSTRACT

System and method for generating quantum-entangled photons. First and second laser sources are coupled to each of a plurality of multi-mode optical fibers. The first laser source is coupled into one guided mode and the second laser source is coupled into another guided mode for each of the fibers. Intermodal four-wave mixing the outputs of the fibers separates the signals. A signal combiner recombines the filtered outputs to produce a broadband source of quantum-entangled photons.

### CROSS-REFERENCE TO RELATED APPLICATION

This application claims the benefit of U.S. Provisional Application No. 63/481,677, filed Jan. 26, 2023, the entire disclosure of which is incorporated herein by reference.

### BACKGROUND

Sources of quantum entangled photons are used in quantum imaging, spectroscopy, microscopy, communication, and computing. With conventional sources, there are limitations on the generation of a truly broadband source of entangled photons. For example, the use of fibers with telecommunication lengths, typically several hundreds of kilometers, is required for applications like space-division multiplexing (SDM). A full characterization of intermodal four-wave mixing (IMFWM) occurring in communication-length few-mode fibers (FMFs) is of great interest to accurately account for nonlinear interactions and estimate their influence on SDM systems. Spontaneous FWM (SFWM) in FMFs is of special importance due to its impact on the capabilities of SDM systems, as well as in applications of wavelength conversion, parametric amplification, and quantum communication.

### SUMMARY

Aspects of the present disclosure permit generation of a truly broadband source of entangled photons.

In an aspect, a system for generating quantum-entangled photons comprises a plurality of multi-mode optical fibers each having a plurality of guided modes. The system also includes a plurality of laser sources. The laser sources comprise first and second laser sources coupled to each of the fibers. The first laser source is coupled into one of the guided modes and the second laser source is coupled into another one of the guided modes for each of the fibers. A plurality of filters, each coupled to an output of one of the fibers, performs four-wave mixing on the outputs. The system further comprises a signal combiner coupled to the filters for combining the filtered outputs of the fibers to produce a broadband source of quantum-entangled photons.

In another aspect a method of generating quantum-entangled photons comprises supplying a first laser signal and a second laser signal to each of a plurality of multi-mode optical fibers. Each of the fibers has at least a first guided mode and a second guided mode and the first laser signal is coupled into the first guided mode and the second laser signal is coupled into the second guided mode. The method also includes transmitting the laser signals via each of the fibers to a corresponding filter and intermodal four-wave mixing, by the corresponding filter, an output of each of the fibers. The method further comprises combining the intermodal four-wave mixed outputs of the fibers to produce a broadband source of quantum-entangled photons.

Other objects and features will be in part apparent and in part pointed out hereinafter.

### BRIEF DESCRIPTION OF DRAWINGS

FIG. 1 illustrates a system for generating quantum-entangled photons according to an embodiment.

FIG. 2 illustrates a system for generating quantum-entangled photons according to another embodiment.

FIG. 3 illustrates a system for generating quantum-entangled photons according to yet another embodiment.

Corresponding reference characters indicate corresponding parts throughout the drawings.

### DETAILED DESCRIPTION

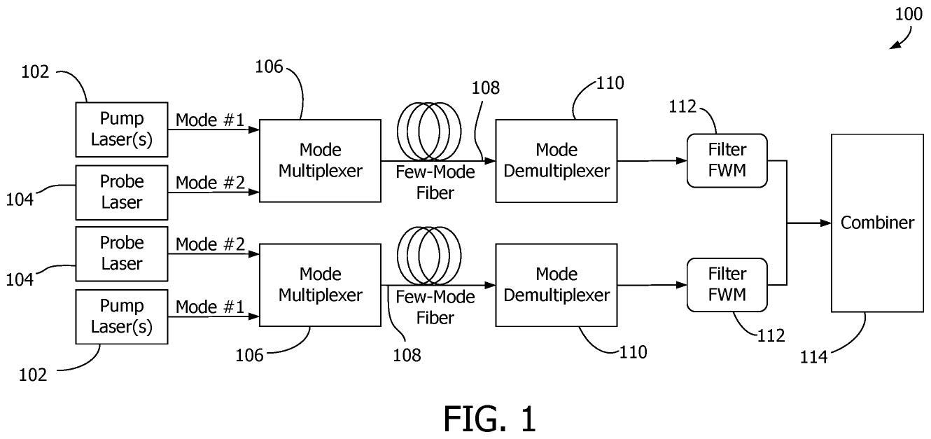

Aspects of the present disclosure permit generation of a truly broadband source of entangled photons. In an embodiment as shown in FIG. 1, a system 100 for generating quantum-entangled photons comprises a plurality of pump lasers 102 (e.g., very narrowband lasers) as well as a probe laser 104 (e.g., a broadband supercontinuum or frequency comb laser). The pump lasers 102 provide energy in a first mode to a mode multiplexer 106 and the probe laser 104 provides energy in a second mode to the mode multiplexer 106. The laser sources 102, 104 are coupled into a multi-mode fiber 108 (shown in FIG. 1 as a few-mode fiber (FMF)) via mode multiplexer 106. It is to be understood that disclosure relating to few-mode fibers likewise applies to multi-mode fibers and vice-versa.

In an embodiment, at least one of the pump lasers 102 and the probe laser 104 are coupled in a higher-order mode of the fiber 108; at least one other of the pump lasers 102 is coupled at the fundamental mode of the fiber 108.

As shown in FIG. 1, system 100 includes one or more duplicate laser-fiber arrangements with multiple pumps and different portions of the frequency comb signal. Each multi-mode fiber 108 feeds into a mode demultiplexer 110 and a proper cascade of fiber-Bragg grating filter design or arrayed waveguide grating, illustrated as filter 112 in FIG. 1, receives the demultiplexed signals and provides four-wave mixing (FWM) between different modes. A phase-matching condition is satisfied among the laser signals for a spontaneous four-wave mixing effect to generate two entangled photons resonantly simultaneously. A combiner 114 combines the various bands covered at different fibers to generate a broadband laser output.

In addition to the physical components of system 100, aspects of the present disclosure relate to a method for separating and recombining signals to generate a broadband source.

When the principles of conservation of energy and momentum (phase matching condition) are concurrently satisfied inside the FMF accompanied with appropriate optical powers, the spontaneous four-wave mixing (SFWM) nonlinear effect is expected to be observed. The phase mismatch can be attributed to waveguide dispersion, material dispersion, and nonlinear phenomena as well as pump detuning from the energy conservation principle. To maximize the effectiveness of the SFWM effect, this phase mismatch between the pump beams at different modes should be zero. The laser wavelength is targeted to be nearly at zero dispersion wavelength (ZDW) for the phase-matching criterion in single-mode fibers (SMFs) to be satisfied. It must be in the anomalous dispersion regime for the waveguide and nonlinear dispersions to cancel the material dispersion. To make sure that each supported spatial mode fits the general phase-matching criteria for a particular intermodal four-wave mixing (IMFWM) process, one can take advantage of the group velocity differences of the supported spatial modes in a FMF. By firing three laser beams, for example, in the different FMF modes in such a way that phase-matching conditions between the three modes are achieved, phase-matching conditions can be attained in the case of non-degenerate stimulated IMFWM in FMFs.

According to embodiments of the present disclosure, phase matching between two laser beams satisfies the spontaneous IMFWM. Intermodal phase-matching can be achieved by carefully choosing the wavelengths for the different modes and taking advantage of the fact that the different modes have different group velocities and propagation constants. For every wave pair with comparable modal features, these wavelengths correspond to the same average group velocity. If the two laser beams have comparable modal characteristics, it is also simple to change their relative polarization by passing them through a coupler and a polarization beam splitter (PBS) before sending them into the fiber.

The pump lasers 102 and the probe laser 104 are separated to satisfy the phase-matching condition. The separation is measured from the chromatic dispersion curve of the two modes of the fiber 108 used for the four-wave mixing effect. In an embodiment, the pump lasers 102 are chosen to be at two distinct frequencies and the signal can be a filtered portion of a frequency comb laser. Various bands are covered at different fibers 108 with multiple copies of the pumps 102 and different portions of the frequency comb signal and then combined at combiner 114 to generate a broadband laser.

The system 100 is configured for continuous wave or pulsed operation and is not limited to the telecommunication laser band. It can be used to generate entangled sources at other optical bands based on the fiber 108. Another advantage is that the entangled photons can be generated in a desired higher-order fiber mode beyond the fiber's fundamental mode.

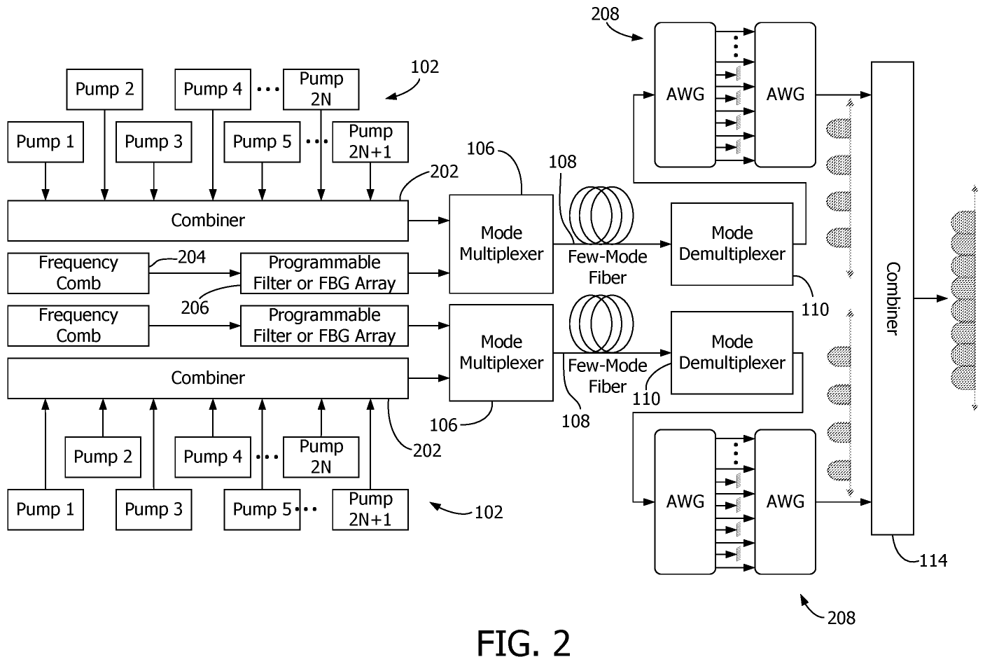

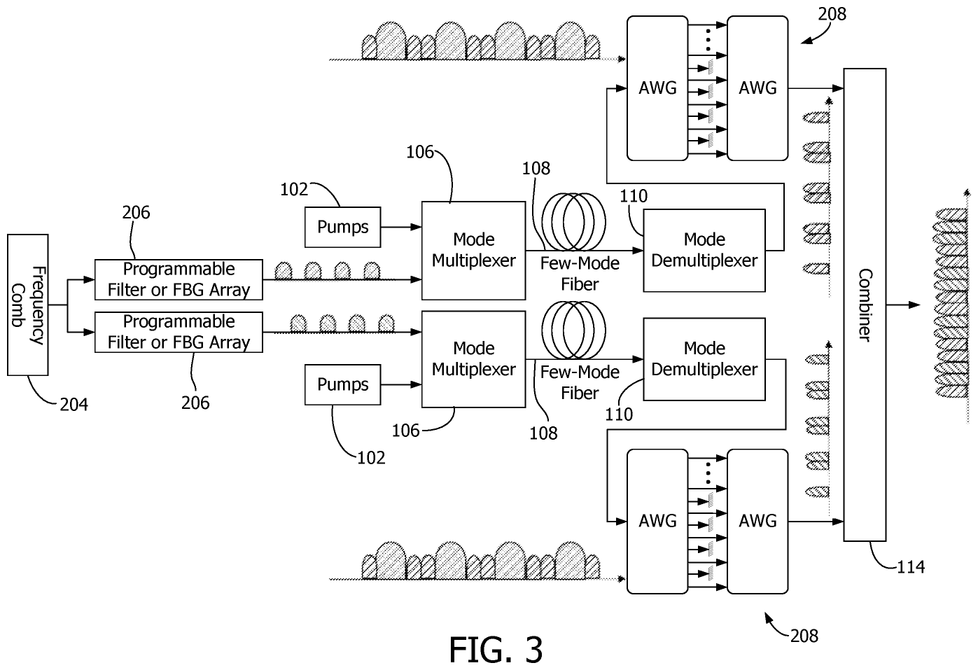

FIG. 2 and FIG. 3 both illustrate example schematics of the broadband laser with alternating bands of entangled photons according to alternative embodiments. As shown, a plurality of pump lasers 102 supply pump energy to mode multiplexer 106. FIG. 2 further illustrates a combiner 202 for combining the pump signals input to mode multiplexer 106. In these embodiments, a frequency comb laser 204 having its output filtered by a programmable filter 206 or a fiber Bragg grating (FBG) array, or the like replaces the probe laser 104. Further, filter 112 is embodied by a pair of arrayed waveguide gratings (AWG) 208, or programmable tunable filters, or the like to filter out any residual frequency comb signal. The combiner 114 outputs a final broadband signal of periodically entangled photons.

Specifically, Error! Reference source not found. FIG. 3 illustrates a detailed schematic of the disclosed broadband laser in the 1550 nm band. Two copies of the pumps 102 are coupled into the higher-order modes of the FMF 108 via mode multiplexer 106, and the signal is coupled into the fundamental mode. The resulting spectra are going through the pair of AWGs 208 to filter out the residual frequency comb signal. The two copies of the spectrum are then combined using a coupler, such as combiner 114. Since the two routes are chosen to be shifted by about 0.5 nm, when combined, the full band is covered centered around 1550 nm. The optical S, C, and L bands are focused upon due to the abundance of telecommunication lasers and detectors within those ranges.

The following describes additional aspects of entangled photon-pair generation via spontaneous intermodal four-wave mixing.

High degrees of security have been achieved in quantum communication over fiber using entangled photons. For communications applications, it is crucial to produce high-yield entangled photon pairs (EPPs) with the capacity to transmit them over lengthy fiber distances and the ability to integrate and transmit them over existing classical communication systems. Since spatial division multiplexing is currently being demonstrated to replace single-mode communication systems, the generation and transferring EPPs in various fiber modes is of interest. Aspect of the present disclosure permit EPP formation in a graded-index FMF via the spontaneous intermodal four-wave mixing (FWM) effect.

In an embodiment, a multi-mode nonlinear platform provides the system with an additional (spatial) degree of freedom in comparison to a single-mode nonlinear platform. As a result, it has the potential to significantly improve the performance of many ultra-fast signal processing applications, including parametric amplification and wavelength conversion. For instance, the multi-mode platform eases phase matching requirements, reducing trade-offs between low noise operation and broadband operation. In particular, the multi-mode platform does not need to operate close to the fiber's zero-dispersion wavelength to accomplish phase matching, hence less nonlinear signal cross-talk is anticipated.

Excess noise contributions, such as spontaneous Raman scattering and broadband amplified spontaneous emission (ASE) from a high-power pump, are another barrier to effective signal amplification or frequency conversion utilizing FWM. Spontaneous Raman scattering is difficult to avoid in single-mode operation since its bandwidths often go beyond the phase-matching bandwidth of the FWM process, but its impact can be lessened by efficient, narrow filtering of the pump. However, due to the various propagation constants of each mode, phase matching can be accomplished for significant wavelength separations if the wave components of the FWM process are excited in various spatial modes. Therefore, by adjusting the dispersion characteristics of the multi-mode fiber so that phase matching is accomplished outside of the spectral bands of these noise sources, the effects of spontaneous Raman scattering and ASE from a high-power pump may be minimized to an inconsequential level. Additionally, FWM in fibers has been employed in quantum communication research to create correlated photon pairs and generally enables frequency conversion of quantum states of light. The latter has been proven in single-mode operation in both a photonic crystal fiber and a dispersion-shifted extremely nonlinear fiber, where phase matching was obtained beyond the Raman spectrum at the expense of inherently small bandwidths. In fully integrated silica-fiber schemes, IMFWM may thus enable important applications for future quantum communication networks. More generally, IMFWM demonstrates its potential to have an impact on many diverse optical areas.

Regarding spontaneous four-wave mixing, the phase matching condition is derived for the non-degenerate SFWM in the FMF 108 by extending the β in a Taylor expansion as in Equation 1 around an arbitrary frequency ω₀ truncated at the third-order term; the phase mismatch resulting from dispersion can be computed. In an embodiment, the configuration of the pump for the IM-SFWM in an FMF identifies ωₛ and ωᵢ as the signal and idler frequencies in the LP11 mode group and LP01 mode, respectively, and ρ₁ and ρ₂ as the pump frequencies in the LP01 mode and LP11 mode group, respectively.

$$β ( ω ) = {β}_{0} + {β}_{1} ( ω - {ω}_{0} ) + \frac{{β}_{2}}{2} {( ω - {ω}_{0} )}^{2} + \frac{{β}_{3}}{6} {( ω - {ω}_{0} )}^{3} + … \qquad ( 1 )$$

Energy conservation and phase matching are the two requirements that must be met for the SFWM to take place. Equation 2 can be used to determine the optical angular frequency of the idler wave (a)), and Equation 3 can be used to determine the necessary phase matching condition and subsequently the phase mismatch which will provide the idler bandwidth. The pump, signal, and idler are identified by the designations ρ, s, and i, respectively.

$${ω}_{i} = {ω}_{p 1} + {ω}_{p 2} - {ω}_{s} \qquad ( 2 )$$

$${β}^{i} = {β}^{p 1} + {β}^{p 2} - {β}^{s} \qquad ( 3 )$$

The phase-mismatch for SFWM as defined in Equation 3 can be written as:

$$Δ β = {β}^{i} - {β}^{p 1} - {β}^{p 2} + {β}^{s} \qquad ( 4 )$$

Since the pump2 and idler are in the same LP11 mode, and the pump1 and signal in LP01, β₀^{s}(ω₀)=β₀^{ρ1}(ω₀)=β₀⁰¹ and β₀ⁱ(ω₀)=β₀^{ρ2}(ω₀)=β₀¹¹. The same equations apply to β₁^{01/11}, β₂^{01/11} so the phase-mismatch can be written as Equation 5 truncated to the third term. At perfect phase mismatch, Δβ=0, and slightly away from the perfect phase-matching condition, will result in a bandwidth for these processes that can be calculated from

$$sin {c}^{2} ( \frac{L Δ β}{2} )$$

equation. L is the fiber length. The signal and idler waves that are expected from this intermodal SFWM, are entangled photons generated due to the FWM between two different modes. The idler is expected to be in LP11 and signal in LP01 mode.

$$Δ β \approx {β}_{1}^{11} ( Δ {ω}_{i} - Δ {ω}_{p 2} ) + \frac{{β}_{2}^{11}}{2} ( Δ {ω}_{i}^{2} - Δ {ω}_{p 2}^{2} ) - {β}_{1}^{01} ( Δ {ω}_{p 1} - Δ {ω}_{s} ) - \frac{{β}_{2}^{01}}{2} ( Δ {ω}_{p 1}^{2} - Δ {ω}_{s}^{2} ) \qquad ( 5 )$$

$${β}_{1}^{11} + \frac{{β}_{2}^{11}}{2} ( Δ {ω}_{i} + Δ {ω}_{p 2} ) = {β}_{1}^{01} + \frac{{β}_{2}^{01}}{2} ( Δ {ω}_{p 1} + Δ {ω}_{s} ) \qquad ( 6 )$$

The order of execution or performance of the operations in embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of aspects of the disclosure.

When introducing elements of aspects of the disclosure or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A system for generating quantum-entangled photons comprising:
a plurality of multi-mode optical fibers, each of the fibers having a plurality of guided modes;
a plurality of laser sources, the laser sources comprising first and second laser sources coupled to each of the fibers, the first laser source coupled into one of the guided modes and the second laser source coupled into another one of the guided modes for each of the fibers;
a plurality of filters, each of the filters coupled to an output of one of the fibers and performing four-wave mixing thereof; and
a signal combiner, the signal combiner coupled to the filters and combining the filtered outputs of the fibers to produce a broadband source of quantum-entangled photons.

2. The system set forth in claim 1, wherein the first laser source comprises a pump laser.

3. The system set forth in claim 1, wherein the first laser source comprises a narrowband laser.

4. The system set forth in claim 1, wherein the second laser source comprises a probe laser.

5. The system set forth in claim 1, wherein the second laser source comprises a broadband laser.

6. The system set forth in claim 5, wherein the broadband laser comprises a supercontinuum laser.

7. The system set forth in claim 5, wherein the broadband laser comprises a frequency comb laser.

8. The system set forth in claim 1, wherein the multi-mode optical fiber comprises a few-mode fiber.

9. The system set forth in claim 1, wherein the filter comprises a cascade of fiber-Bragg grating filters.

10. The system set forth in claim 1, wherein the filter comprises an arrayed waveguide grating.

11. A method of generating quantum-entangled photons comprising:
supplying a first laser signal and a second laser signal to each of a plurality of multi-mode optical fibers, wherein each of the fibers has at least a first guided mode and a second guided mode, and wherein the first laser signal is coupled into the first guided mode and the second laser signal is coupled into the second guided mode;
transmitting the laser signals via each of the fibers to a corresponding filter;
intermodal four-wave mixing, by the corresponding filter, an output of each of the fibers; and
combining the intermodal four-wave mixed outputs of the fibers to produce a broadband source of quantum-entangled photons.

12. The method set forth in claim 11, further comprising multiplexing, for each of the fibers, the first and second laser signals supplied thereto for transmission via the fibers.

13. The method set forth in claim 12, further comprising demultiplexing the multiplexed first and second laser signals transmitted via the fibers before intermodal four-wave mixing.

14. The method set forth in claim 13, wherein the second laser signal is generated by broadband laser comprises a frequency comb laser and further comprising filtering any residual frequency comb signal from the demultiplexed first and second laser signals.

15. The method set forth in claim 14, wherein the filter comprises a cascade of fiber-Bragg grating filters.

16. The method set forth in claim 14, wherein the filter comprises an arrayed waveguide grating.

17. The method set forth in claim 10, wherein the multi-mode optical fibers each comprises a few-mode fiber.

18. The method set forth in claim 10, wherein supplying the first laser signal comprises generating a plurality of pump laser signals and combining the plurality of pump laser signals into the first laser signal.

19. The method set forth in claim 10, wherein the outputs of the fibers comprise copies of spectra shifted relative to each other and combining the intermodal four-wave mixed outputs of the fibers to produce the broadband source of quantum-entangled photons comprises coupling the copies of spectra.

20. The method set forth in claim 10, wherein the first and second guided modes of the fibers correspond to different wavelengths and wherein intermodal four-wave mixing, comprises phase matching the output of each of the fibers.
